(19) United States
(12) Patent Application Publication
(10) Pub. No.: US 2004/0255432 A1
(43) Pub. Date: Dec. 23, 2004

(54) Hose clamping device

(76) Inventor: Christian Ruppel, Schmitten (DE)

Correspondence Address: Mayer Brown, Rowie & Maw, 190 South La Salle Street, Chicago, IL, 60603-3441, US

(21) Appl. No.: 10/492,608

(22) PCT Filed: Sep. 12, 2002
(86) PCT No.: PCT/DE02/03401

(30) Foreign Application Priority Data
Oct. 18, 2001 (DE) 101 50 897.2

(51) Int. Cl. F16L 33/00

(52) U.S. Cl. 24/20 CW

(57) ABSTRACT

The invention relates to a hose clamping device, comprising a clamping ring (2) for clamping a hose (8), pushed upon a tail piece (5), by radially inwardly pretensioning said hose. Said clamping ring (2) can elastically expand radially and said hose clamping device comprises an expanding element, which can be subjected to a force for radially outwardly expanding said clamping ring (2).

The invention relates to a tube-clamping device with a clamping ring by means of which a tube which is pushed onto a tube connection stub is clamped with radially inwardly directed prestressing, and to a method for installing and fastening a tube on a tube connection stub by means of such a tube-clamping device.

Such known tube-clamping devices have an ear-like convexity which is located on a clamping ring and, once the tube has been pushed onto the tube connection stub, is drawn together by means of a tool, deforming in the process, the clamping ring thus enclosing the tube, which is seated on the tube connection stub, with prestressing.

The installation of the tube by means of this tube-clamping device involves high outlay, in particular as a result of the operation of deforming the ear-like convexity, and, in addition, cannot be carried out fully automatically.

DE 37 27 908 discloses a tube-clamping device of which the tube clamp comprises an axially split annular body. The end parts of the annular body overlap one another in the circumferential direction and each have a lug-like protrusion extending approximately radially outward. The annular body is opened up asymmetrically by the two protrusions being pressed together.

The object of the invention is thus to provide a tube-clamping device of the type mentioned in the introduction which is of straightforward construction, can be easily installed and allows a method, for installing and fastening the tube on the tube connection stub, which only requires a small number of straightforward installation steps.

This object is achieved according to the invention in that the clamping ring can be widened in a radially elastic manner, and in that the tube-clamping device has an expansion element which can be forced the clamping ring to expand radially outward, the clamping ring, along its circumferential extent, having one or more resilient regions, by means of which the clamping ring can be widened elastically in the direction of the circumferential extent.

By virtue of this design, all that is necessary is for the clamping ring, widened by the force applied by the expansion element, to be positioned on the tube connection stub, for the tube, projecting through the clamping ring, to be pushed onto the tube connection stub and for the force applied by the expansion element to be terminated, in order to achieve a ready installed tube. This is easily possible even in a fully mechanical manner without any additional deformation operation. It is only when the expansion element is relieved of force that the clamping ring then encloses the tube and tube connection stub with the necessary radially inwardly directed prestressing.

It is possible to increase the extent of the possible diameter widening by means of one or more resilient regions along the circumferential extent of the clamping ring. It is thus also possible for the radial clamping force of the clamping ring to be defined more precisely.

It is possible here for the expansion element to be formed integrally with the clamping ring.

In another embodiment, it is possible for the expansion element to be arranged on an insert ring which is slit continuously along its longitudinal extent and is enclosed by the clamping ring. By virtue of the force applied by the expansion element, the insert ring widens and also expands the clamping ring via its outer radially encircling lateral surface.

In order for it to be possible for the clamping ring to be widened by virtue of axial force applied by the expansion element, it is possible, in the direction of its end which is directed away from the clamping ring, for the expansion element to be designed such that it moves away from the longitudinal axis of the clamping ring.

For uniform expansion of the clamping ring over its circumference, the expansion element may have one or more arms which are arranged in a funnel-like manner on the clamping ring or on the insert ring, the force applied axially by said arms directly or indirectly widening the diameter of the clamping ring. In the case of a single arm, the latter forms a funnel which can be widened radially to good effect by a continuous slit in the longitudinal direction.

The arms may also be of basket-like design.

A further likewise advantageous design of the expansion elements consists in that the expansion element is formed by two or more rear-engagement elements which can be forced radially outward and can be forced in approximately opposite directions for radial widening by an installation tool.

For this purpose, the elements which can be subjected to forcing action are preferably distributed approximately uniformly on the circumference of the clamping ring or of the insert ring.

For the secure rear engagement by an installation tool, the elements which can be subjected to forcing action may be of hook-like design.

It is preferable for -the resilient regions to be distributed uniformly on the circumference of the clamping ring.

A possible way of producing the resilient regions straightforwardly is for the resilient regions to be designed as ear-like convexities of the clamping ring.

If the expansion element has a slide coating on its radially inwardly directed surface, then the force applied axially can be limited, without significant frictional losses, largely just to the force which is necessary for widening the diameter of the clamping ring.

A method of installing and fastening a tube on a tube connection stub by means of a tube-clamping device of the type described is possible, with a small number of straightforward method steps, if an expansion element forces a clamping ring to widen radially outward and the clamping ring, or the clamping ring enclosing an insert ring, is positioned in its axial end position on a tube connection stub, if, maintaining the force applied by the expansion element and the widening of the clamping ring or of the clamping ring and of the insert ring, the tube, projecting through the clamping ring or the insert ring, is pushed onto the tube connection stub, and if the expansion element is then relieved of force again.

An exemplary embodiment of the invention is described in more detail hereinbelow and illustrated in the drawing, in which:

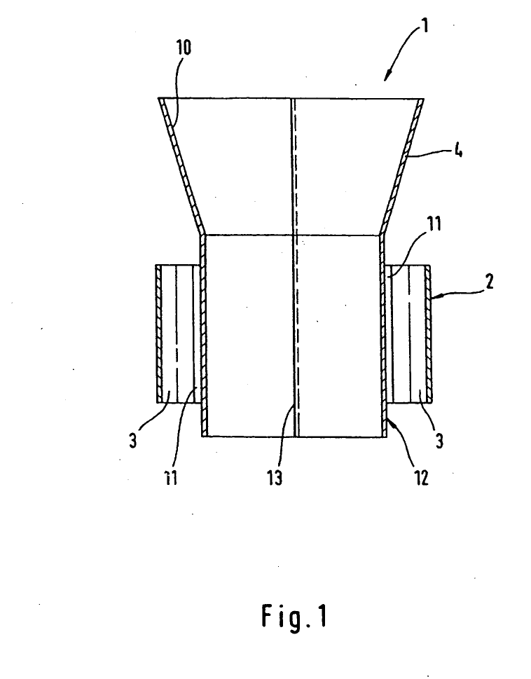

FIG. 1 shows a first exemplary embodiment of a tube-clamping device in cross section,

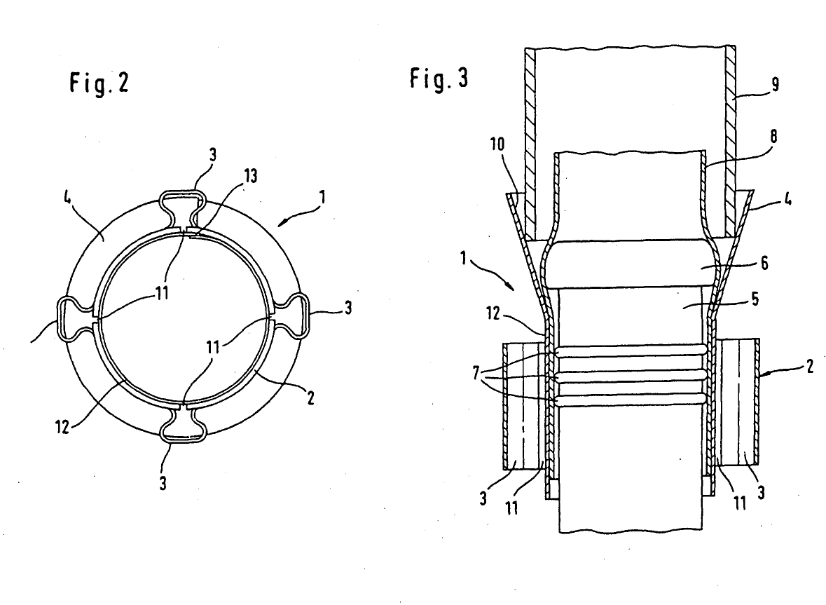

FIG. 2 shows a bottom view of the tube-clamping device according to FIG. 1,

FIG. 3 shows a cross section of the tube-clamping device according to FIG. 1, said device being arranged on a tube connection stub bearing a tube,

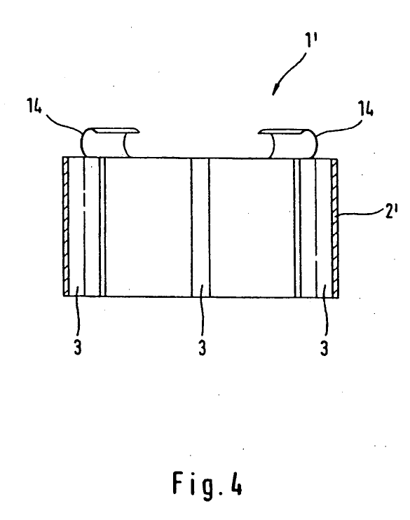

FIG. 4 shows a second exemplary embodiment of a tube-clamping device in cross section,

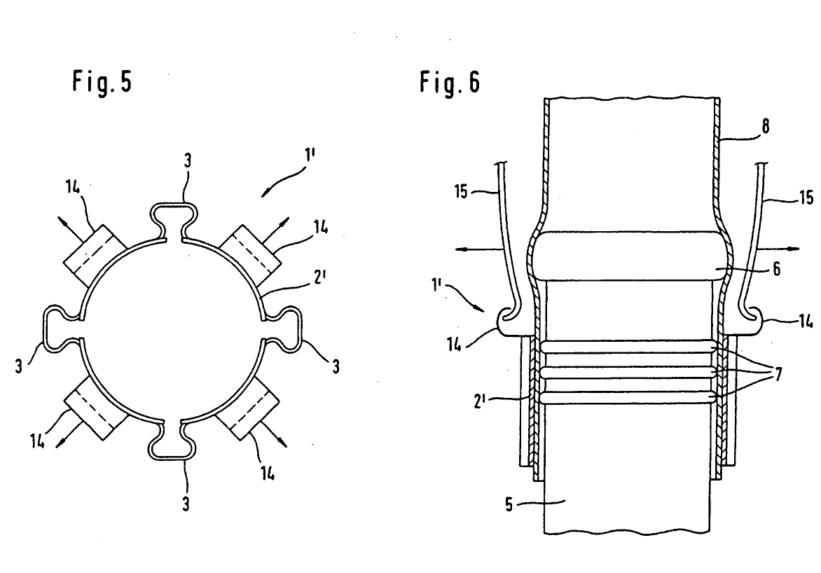

FIG. 5 shows a bottom view of the tube-clamping device according to FIG. 4, and

FIG. 6 shows a cross section of the tube-clamping device according to FIG. 4, said device being arranged on a tube connection stub bearing a tube.

The tube-clamping device 1 illustrated in FIGS. 1 to 3 has a clamping ring 2 which has four ear-like convexities 3 which are distributed uniformly on its circumference and act as resilient regions. The ear-like convexities 3 here bridge longitudinally continuous slits 11 in the clamping ring 2, with the result that four clamping-ring elements are formed as a result.

The clamping ring 2 encloses the cylindrical part of an insert ring 12, which likewise has a longitudinal slit 13. The ends of the insert ring 12 are located one upon the other in an overlapping manner in the region of the longitudinal slit 13.

At one end, the cylindrical part of the insert ring 12 is adjoined by an expansion element, which widens in the form of a funnel 4 and in which the longitudinal slit 13 continues.

FIG. 3 illustrates a tube connection stub 5 which is provided with a nipple 6 at its free end and with three radially encircling ribs 7, at a distance from said nipple, on its outer lateral surface.

Pushed onto the tube connection stub 5 is the end of a tube 8 which, in turn, is enclosed by the insert ring 12, as is the latter by the clamping ring 2, with the radially inwardly directed prestressing. In this case, the funnel 4 of the insert ring 12 projects away from the tube connection stub 5.

A tubular installation aid 9 encloses the end region of the tube 8 and has its free end butting against the inner slope 10 of the funnel 4.

In order to install the tube-clamping device and tube 8, the installation aid 9, by virtue of being forced axially in the direction of the tube connection stub 5, slides along the inner slope 10 of the funnel 4 and thus results in a widening of the insert ring 12 which, in turn, via its outer lateral surface, widens the clamping ring 2 counter to the resilient force of the convexities 3.

The clamping ring is then positioned, by way of the insert ring 12, on the tube connection stub 5 and, maintaining the forcing action to which the funnel 4 is subjected by the installation aid 9, the tube 8 is pushed, through the installation aid, onto the tube connection stub 5. By virtue of the widening of the insert ring 12 and clamping ring 1, the latter cannot be obstructive.

If the tube has reached its final position, the forcing action to which the funnel 4 is subjected by the installation aid 9 is terminated, with the result that the clamping ring 2 can be deformed back into shape and then braces the tube 8 firmly, via the insert ring 12, on the tube connection stub 5.

The tube-clamping device 1′ illustrated in FIGS. 3 to 4 has a clamping ring 2′, which likewise has four circumferentially distributed ear-like convexities 3 of the same design and with the same function as in the exemplary embodiment of FIGS. 1 to 3.

Arranged integrally with the clamping ring 2′, between the convexities 3, at one end, are hook-like elements 14, behind which, as can be seen in FIG. 6, an installation tool 15 can engage and force them radially outward. It is thus possible for the clamping ring 2′ to be positioned on the tube connection stub 5 in the expanded state, its diameter being increased in the process, and, maintaining the forcing action to which the hook-like elements 14 are subjected by the installation tool 15, for the tube 8 to be pushed onto the tube connection stub 5. By virtue of the widening of the clamping ring 1′, the latter cannot be obstructive.

If the tube 8 has reached its final position, the forcing action to which the hook-like elements 14 are subjected by the installation tool 15 is terminated, with the result that the clamping ring. 2′ can be deformed back into shape and then braces the tube 8 firmly on the tube connection stub 5.

1. A tube-clamping device with a clamping ring by means of which a tube which is pushed onto a tube connection stub is clamped with radially inwardly directed prestressing, characterized in that the clamping ring (2, 2′) can be widened in a radially elastic manner, and in that the tube-clamping device (1, 1′) has an expansion element which can be forced the clamping ring (2, 2′) to expand radially outward, the clamping ring (2, 2′), along its circumferential extent, having one or more resilient regions, by means of which the clamping ring (2, 2′) can be widened elastically in the direction of the circumferential extent.

2. The tube-clamping device as claimed in claim 1, characterized in that the expansion element is formed integrally with the clamping ring (2′).

3. The tube-clamping device as claimed in claim 1, characterized in that the expansion element is arranged on an insert ring (12) which is slit continuously along its longitudinal extent and is enclosed by the clamping ring (2).

4. The tube-clamping device as claimed in one of the preceding claims, characterized in that, in the direction of its end which is directed away from the clamping ring (2), the expansion element is designed such that it moves away from the longitudinal axis of the clamping ring (2).

5. The tube-clamping device as claimed in claim 4, characterized in that the expansion element has one or more arms which are arranged in a funnel-like manner on the clamping ring or on the insert ring (12).

6. The tube-clamping device as claimed in claim 5, characterized in that the arms are of basket-like design.

7. The tube-clamping device as claimed in one of claims 1 to 3, characterized in that the expansion element is formed by two or more rear-engagement elements which can be forced radially outward.

8. The tube-clamping device as claimed in claim 7, characterized in that the elements which can be subjected to forcing action are distributed approximately uniformly on the circumference of the clamping ring (2′) or of the insert ring.

9. The tube-clamping device as claimed in either of claims 7 and 8, characterized in that the elements (14) which can be subjected to forcing action are of hook-like design.

10. The tube-clamping device as claimed in one of the preceding claims, characterized in that the resilient regions are distributed uniformly on the circumference of the clamping ring (2, 2′).

11. The tube-clamping device as claimed in one of the preceding claims, characterized in that the resilient regions are designed as ear-like convexities (3) of the clamping ring (2, 2′).

12. The tube-clamping device as claimed in one of the preceding claims, characterized in that the expansion element has a slide coating on its radially inwardly directed surface.

13. A method of installing and fastening a tube on a tube connection stub by means of a tube-clamping device as claimed in one of claims 1 to 12, characterized in that an expansion element forces a clamping ring (2, 2′) to widen radially outward and the clamping ring (2′), or the clamping ring (2) enclosing an insert ring (12), is positioned in its axial end position on a tube connection stub (5), in that, maintaining the force applied by the expansion element and the widening of the clamping ring (2′) or of the clamping ring (2) and of the insert ring (12), the tube (8), projecting through the clamping ring (2′) or the insert ring (12), is pushed onto the tube connection stub (5), and in that the expansion element is then relieved of force again.
This object is achieved according to the invention in that the clamping ring can be widened in a radially elastic manner, and in that the tube-clamping device has an expansion element which can be forced the clamping ring to expand radially outward.
By virtue of this design, all that is necessary is for the clamping ring, widened by the force applied by the expansion element, to be positioned on the tube connection stub, for the tube, projecting through the clamping ring
